(19) United States
(12) Patent Application Publication
(10) Pub. No.: US 2009/0058838 A1
(43) Pub. Date: Mar. 5, 2009

(54) Source driver, display device and system having the same, and data output method thereof

(75) Inventors: Sang-Min Lee, Seongnam-si (KR); Yang-Wook Kim, Seoul (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 12/230,296

(22) Filed: Aug. 27, 2008

(30) Foreign Application Priority Data
Aug. 28, 2007 (KR) 10-2007-086648

(51) Int. Cl. G09G 5/00; G09G 3/36

(52) U.S. Cl. 345/204; 345/87

(57) ABSTRACT

Disclosed is an output method of a source driver, which may include the steps of receiving image data, converting the image data into analog image signals, and distributionally outputting the analog image signals based on pluralities of delayed control signals, wherein the pluralities of delayed control signals may be generated by delaying an external control signal.

### FOREIGN PRIORITY STATEMENT

This U.S. non-provisional patent application claims priority under 35 U.S.C. §119 to Korean Patent Application No. 10-2007-0086648, filed on Aug. 28, 2007, in the Korean Intellectual Property Office (KIPO), the entire contents of which are incorporated herein by reference.

### BACKGROUND

Example embodiments disclosed herein relate to display devices. More particularly, example embodiments disclosed herein are concerned with a source driver, a display device including the source driver, and a data output method thereof.

With the technical evolution of information society, requirements for display units in applications may increase. In response to those requirements, in recent years, various kinds of flat panel display units have been studied, including, for example liquid crystal display (LCD) devices, plasma display panels (PDPs), electro-luminescent display (ELD) devices, and vacuum fluorescent display (VFD) devices, some of which may already be employed as display units in several devices.

LCDs may be widely used, replacing the traditional cathode ray tubes (CRTs), as mobile display units because they may have many advantages which may include high picture quality, thinness, and low power consumption. Nowadays, LCDs may be developed for diverse applications which may include monitors of televisions receiving broadcasting signals, and computer systems, in addition to laptops, portable multimedia players (PMPs), and navigation systems.

Such an LCD device may be roughly composed of an LCD panel on which image signals may be expressed, and a drive circuit which may apply external drive signals to the LCD panel. The LCD panel may be a display component where liquid crystals may be injected between two transparent substrates, for example glass substrates, that may be coupled with a space. One of the substrates may include pluralities of gate lines arranged in a constant interval, pluralities of data lines regularly arranged vertical to the gate lines, pluralities of pixel electrodes disposed at pixel regions arranged in a matrix defined by the gate and data lines, and pluralities of thin-film transistors (TFTs) which may be used to apply signals to the pixel electrodes from the gate and data lines. The thin-film transistors may be formed at intersections by the gate and data lines. A color filter layer, a common electrode, and a black matrix layer may be disposed on the other substrate. With the structure, whenever turn-on signals are sequentially supplied to the gate lines, data signals may be applied to the pixel electrodes of the corresponding lines and then an image may be displayed on the panel.

Additionally, on the backside of the two substrates, which may be adhesively coupled to each other, a backlight may be provided and may provide a uniform light source to the panel. A cold cathode fluorescent lamp (CCFL), which may be used as a light source for the backlight, may be characterized such that luminance has an inverse relationship with the lifetime thereof. For instance, a lifetime may decrease if the backlight is driven by high current for raising luminance. Thus, it may be difficult to accomplish high luminance because a longer lifetime may accompany a lower rate of current.

Many product applications may require high luminance and long lifetime. For those requirements, there is a technique which may extend an active domain for luminance of the display device by timely supplying a large current to a lamp of the backlight, if there is a need of driving a high-luminance image, while driving a screen with normal luminance in a general LCD device.

Generally, because an LCD device may have a number of data lines that increases along with the resolution thereof, pluralities of source drivers SD1˜SD8 may be provided to the LCD device as shown in FIG. 1. The plural source drivers may be connected to a timing controller (not shown) through a single common interconnection. The source drivers may receive and store image data, which may correspond to a dot, from the timing controller by way of the common interconnection in sequence. After storing all image data corresponding to a line, the source drivers may output the image data to the data line at the same time.

The stored image data may be converted into analog signals through a digital-to-analog converter (DAC) from the source drivers. The converted analog signals may be enhanced in drivability by output buffers and output to the plural data lines at the same time. In recent years, according to the trends of enlargement in TFT-LCD screens for television sets, it may be inevitable for display units to operate with very large quantities of loads which may be composed mostly of capacitive and resistive components. Further, display units may now be changing to have high resolution, which may result in larger numbers of data lines and source drivers for driving, for sharp images. It may be necessary to enable a fast output rate for a high frequency operation, which may be directed to eliminate an afterimage from a screen, so that a relatively high amount of current may be dissipated through the output buffer. As a result, a rate of current consumption may be much higher in the initial output operation, and may be accompanied with very abrupt current peaks. These current peaks may be radiated in the form of an electromagnetic wave, which may deteriorate the characteristic of electromagnetic interference (EMI) between paths.

### SUMMARY

Example embodiments may solve the aforementioned problems by providing a display device which may be capable of reducing EMI and a data output method thereof.

A display device according to example embodiments may operate by distributionally transferring analog voltages, not in a single lump, to a panel in order to lessen EMI.

According to example embodiments, a source driver of the display device may include an output control circuit which may enable output data to be sequentially provided to the panel.

In the display device according to example embodiments, the output control circuit may drive output amplifiers of the source driver in sequence, not at the same time.

Example embodiments may provide an output method of a source driver which may comprise: receiving image data; converting the image data into analog image signals; and distributionally outputting the analog image signals.

According to example embodiments, outputting the image signals may be comprised of amplifying the image signals.

According to example embodiments, the image signals may be divided into pluralities of groups which may be independently amplified.

According to example embodiments, outputting the image signals may further be comprised of generating pluralities of control signals by delaying an external control signal The control signals may each be correspondingly applied to the groups.

According to example embodiments, the control signals may be delayed by a predetermined time in sequence.

According to example embodiments, the control signals may be adjacently delayed between by predetermined times. The control signals output from both ends of a source driver may be generated at the same time. The image signals responding to the control signals may delayed in a form of function.

Example embodiments may provide a source driver which may include: a data latch block receiving and storing image data; a digital-to-analog converter transforming the image data into analog signals; and an output amplifier block distributionally outputting the analog signals in response to pluralities of control signals.

According to example embodiments, the source driver may further include an output control circuit generating the plural control signals.

According to example embodiments, the output control circuit may generate the plural control signals by delaying an external control signal.

According to example embodiments, the plural control signals may be generated with delays by a predetermined time in sequence.

According to example embodiments, the control signals may be adjacently delayed by the predetermined time. The control signals output from both ends of the source driver may be generated at the same time.

According to example embodiments, the output control circuit may comprise pluralities of inverters.

According to example embodiments, the output control circuit may comprise pluralities of flipflops outputting the plural control signals in sync with a shift clock.

Example embodiments may also provide a display device which may include the source driver which may include: a data latch block receiving and storing image data; a digital-to-analog converter transforming the image data into analog signals; and an output amplifier block distributionally outputting the analog signals in response to pluralities of control signals.

According to example embodiments, the display device may express grays by applying a voltage

According to example embodiments, the display device may be one of liquid crystal or electro-chromic display device.

Example embodiments may further provide a display system that may include: a host; and a display device receiving image data and control signals and displaying an image, in which the display device is configured by including the source driver including: a data latch block receiving and storing image data; a digital-to-analog converter transforming the image data into analog signals; and an output amplifier block distributionally outputting the analog signals in response to pluralities of control signals.

A further understanding of the nature and advantages of example embodiments may be realized by reference to the remaining portions of the specification and the attached drawings.

### BRIEF DESCRIPTION OF THE FIGURES

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a diagram of a conventional display device;

FIG. 2 is a block diagram of a display device according to example embodiments;

FIG. 3 is a block diagram showing an embodiment of the source driver according to example embodiments;

FIG. 4 is a timing diagram showing a feature of driving the source driver of FIG. 3;

FIG. 5 is a block diagram illustrating a the output control circuit shown in FIG. 3 according to example embodiments;

FIG. 6 is a block diagram illustrating the output control circuit shown in FIG. 3 according to example embodiments;

FIG. 7 is a block diagram illustrating a display device including eight source drivers;

FIGS. 8A through 8F show various output waveforms from the data drive circuits of the source drivers according to example embodiments;

FIGS. 9A and 9B show the output control circuit for the output waveforms shown in FIG. 8A according to example embodiments, FIG. 9A illustrating the output control circuit with inverters while FIG. 9B illustrating the output control circuit with flipflops;

FIGS. 10A and 10B show the output control circuit for the output waveforms shown in FIG. 8B according to example embodiments, FIG. 10A illustrating the output control circuit with inverters while FIG. 10B illustrating the output control circuit with flipflops;

FIGS. 11A and 11B show the output control circuit for the output waveforms shown in FIG. 8C according to example embodiments, FIG. 11A illustrating the output control circuit with inverters while FIG. 11B illustrating the output control circuit with flipflops;

FIGS. 12A and 12B show the output control circuit for the output waveforms shown in FIG. 8D according to example embodiments, FIG. 12A illustrating the output control circuit with inverters while FIG. 12B illustrating the output control circuit with flipflops;

FIGS. 13A and 13B show the output control circuit for the output waveforms shown in FIG. 8E according to example embodiments, FIG. 13A illustrating the output control circuit with inverters while FIG. 13B illustrating the output control circuit with flipflops;

FIGS. 14A and 14B show the output control circuit for the output waveforms shown in FIG. 8F according to example embodiments, FIG. 14A illustrating the output control circuit with inverters while FIG. 14B illustrating the output control circuit with flipflops; and

FIG. 15 is a block diagram of a display system including the display device according to example embodiments;

FIGS. 16A and 16B show current waveforms consumed through the source driver;

FIGS. 17A and 17B show the current waveforms of FIGS. 16A and 16B in frequency domain; and

FIG. 18 shows a simulation result to frequency characteristics for current.

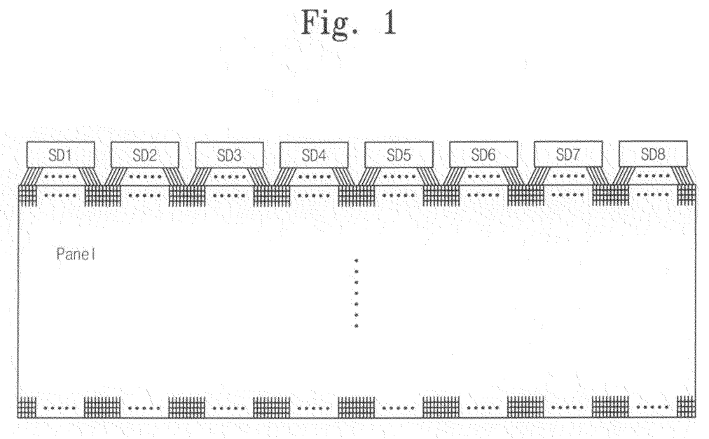

### DETAILED DESCRIPTION OF EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

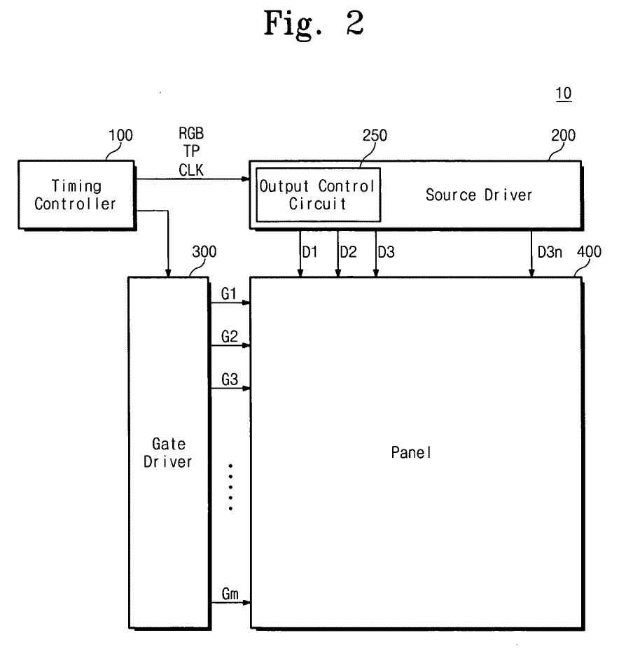

FIG. 2 is a block diagram of a display device 10 according to example embodiments. Referring to FIG. 2, the display device 10 may be comprised of a timing controller 100, a source driver 200, a gate driver 300, and a panel 400. The display device 10 shown in FIG. 2 may be a kind of LCD device. But example embodiments may not be restrictive to LCD types. Example embodiments may also be applicable to a kind of non-emissive display device that may express gray images by applying voltages thereto. For instance, it may be easily understood by those skilled in the art that the display device 10 may be an electro-chromic display (ECD) device. The source driver 200 according to example embodiments may be comprised of an output control circuit 250 to distribute time points of outputting data-line drive signals D1˜D3n in order to lessen EMI.

The timing controller 100 may output image data signals R, G, and B (hereinafter, referred to as ‘RGB’), which may be provided from a host (not shown), in adjustment to be suitable for timings required by the source driver 200 and the gate driver 300. Additionally, the timing controller 100 may output control signals TP, DIO, and POL to control the source and gate drivers 200 and 300.

The source driver 200 may receive the image data signals RGB from the timing controller 100 and may distributionally output the data-line drive signals D1˜D3n of the panel 400 in response to the control signal TP. The data-line driver signals D1˜D3n may be output distributionally, from the timing controller 100, by being output in the form of functions to transfer pixel data into pixels, respectively, through data lines. The source driver 200 may include the output control circuit 250 for generating pluralities of delayed control signals in response to the control signal TP. The source driver 200 may output each of the data-line drive signals D1˜D3n in response to each of the corresponding delayed control signals. According to example embodiments, delay patterns of the data-line driver signals D1˜D3n may be flexible in various forms, which will be detailed in conjunction with FIG. 3 later.

The gate driver 300 may generate gate-line drive signals G1˜Gm for sequentially driving gate lines (not shown) in response to the control signal TP output from the timing controller 100.

The panel 400 may include the gate lines, the data lines (not shown), which may be arranged to intersect the gate lines, and pixels which may be coupled to the gate and data lines. The pixels may be implemented to display grays in accordance with the data-line drive signals applied thereto through the data lines.

The display device 10 according to example embodiments may output the data-line drive signals D1˜D3n in separate groups, and not in a single lump. Thus, the data-line drive signals D1˜D3n may not all be transferred to the panel 400 at the same time. As a result, it may be possible to lessen an abrupt fluctuation of the current, or the maximum current, consumed through the source driver 200. This reduction of current variation rate may contribute to reducing EMI.

FIG. 3 is a block diagram showing the source driver 200 according to example embodiments. Referring to FIG. 3, the source driver 200 may be comprised of a shift register block 210, a data latch block 220, a digital-to-analog converter (DAC) 230, an output buffer block 240, and the output control circuit 250. According to example embodiments, the output control circuit 250 may generate control signals DTP1˜DTPn for delaying activation points of output buffers A1˜A3n in response to the control signal TP. The whole delay rate of the control signals DTP1˜DTPn may be configured so that they do not negatively alter picture quality by affecting a charge rate of the panel 400.

The shift register block 210 may store the digital image data RGB, which may be input from the timing controller 100, as information for each pixel (3 pixels=1 dot) in sync with a clock CLK. The data latch block 220 may store the digital image data RGB, according to selection by the shift register block 210, in sync with the clock CLK. The DAC 230 may convert the digital image data RGB of the data latch block 220 into analog data signals. The output buffer block 240 may amplify the analog data signals, which may be output from the DAC 230, in response to the control signals DTP1˜DTPn and may output the amplified analog data signals to the data lines. The control signals DTP1˜DTPn may be made by sequentially delaying the control signal TP through the output control circuit 250.

The control signals DTP1˜DTPn shown in FIG. 3 may operate to drive the output amplifiers A1˜A3n each by three units. For example, the control signal DTP1 may drive the output amplifiers A1˜A3 and the control signal DTP2 may drive the output amplifiers A4˜A6. The control signal DTPn may drive the output amplifiers A3n-2˜A3n.

For convenience of description, it may be assumed that the output control circuit 250 generates n control signals, DTP1˜DTPn. The number of the control signals, n, may be variable. Here, the number of the control signals, n, may result from dividing the number of outputs of the source driver 200 by a multiple of 3.

According to example embodiments, the source driver 200 may drive the output amplifiers A1˜A3n in response to the delayed control signals DTP1˜DTPn. The data-line drive signals D1˜D3n of the source driver 200 may be sequentially output, in individual groups of three, at different times, not in a single lump. Thus, according to example embodiments, an abrupt variation of a current consumption rate may be reduced in outputting the data-line drive signals D1˜D3n, relative to a conventional source driver. This may reduce EMI.

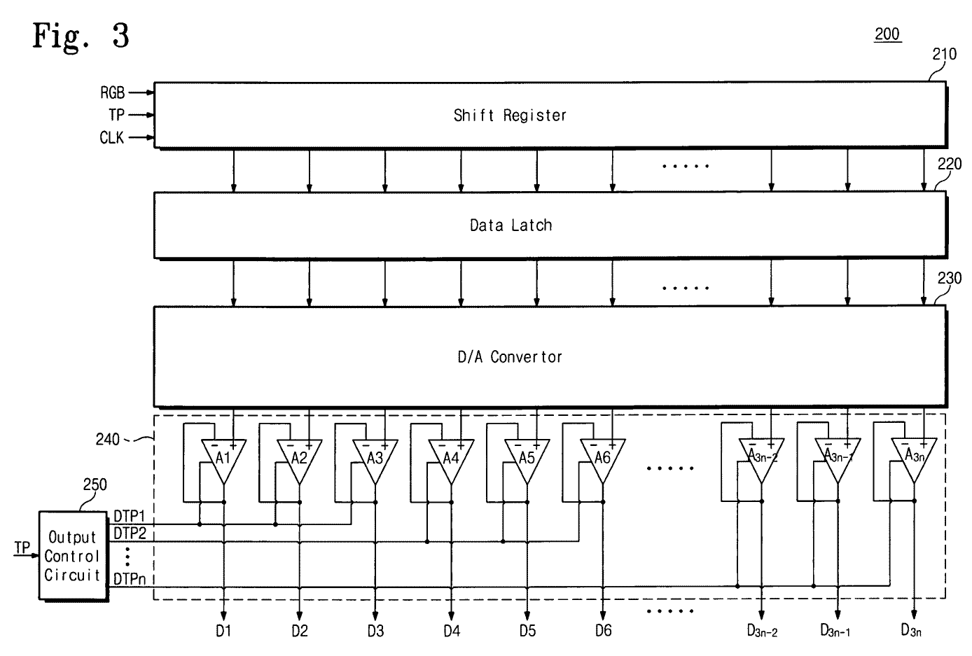

FIG. 4 is a timing diagram illustrating an example of driving the source driver 200 of FIG. 3 according to example embodiments. Referring to FIGS. 3 and 4, the source driver 200 may generate pluralities of the delayed control signals DTP1˜DTPn in response to the control signal TP. The delayed control signals DTP1˜DTPn may function to drive the output buffers A1˜A3n. The source driver 200 may output the data-line drive signals D1˜D3n delayed in response each to the delayed control signals DTP1˜DTPn. Meanwhile, the gate lines may also be driven in response to the control signal TP.

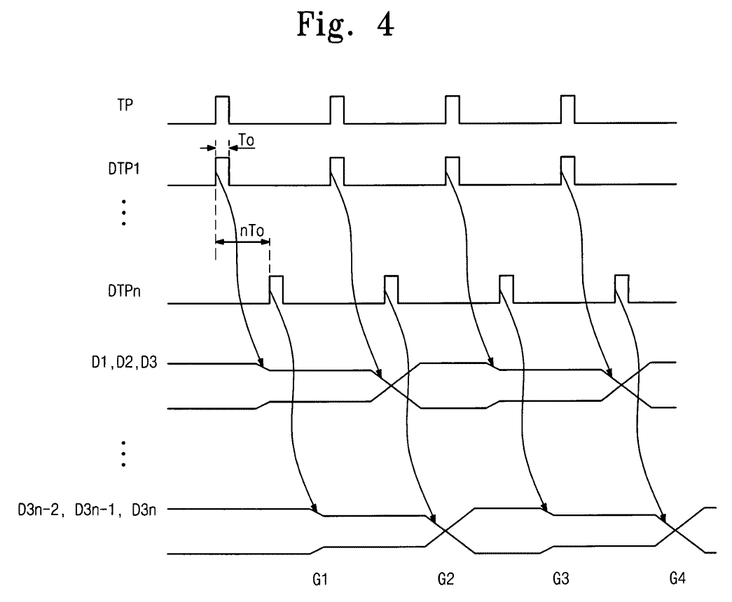

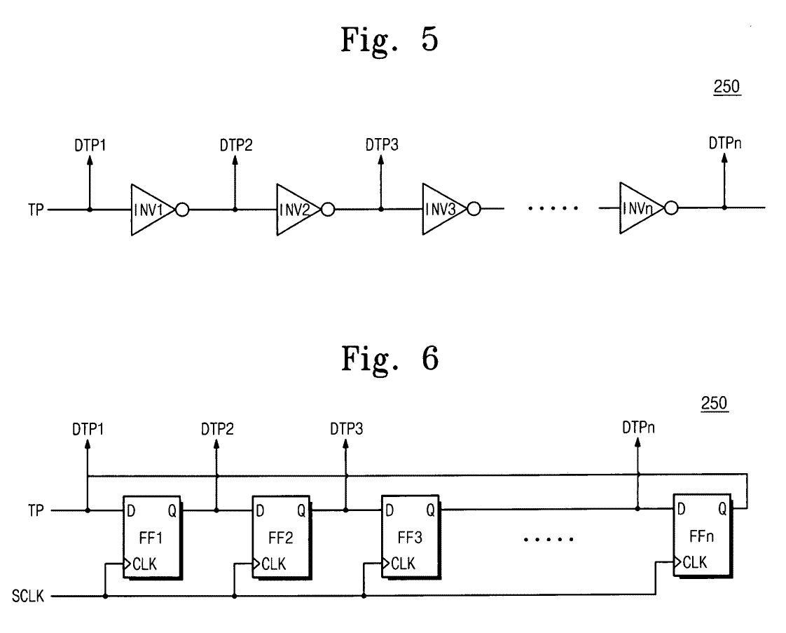

FIG. 5 is a block diagram illustrating the output control circuit 250 shown in FIG. 3 according to example embodiments. Referring to FIG. 5, the output control circuit 250 may include pluralities of inverters INV1˜INVn. The inverters INV1˜INVn may be configured to delay the control signal TP by a delay time T_{D} in succession.

FIG. 6 is a block diagram illustrating the output control circuit 250 shown in FIG. 3 according to example embodiments. Referring to FIG. 6, the output control circuit 250 may include pluralities of flipflops FF1˜FFn. The flipflops FF1˜FFn may output their input signals in sync with a shift clock SCLK. The shift clock SCLK may oscillate in a cycle period with the delay time T_{D}, and may be generated by modifying the clock CLK input to the source driver 200. Thereby, the flipflops FF1˜FFn may output the delayed control signals DTP1˜DTPn, respectively, in response to the control signal TP.

The display device 10 shown in FIG. 2 may be comprised of only one source driver 200. But there may be a limit to the data line which can be driven by a single source driver because of a physical dimension thereof. A general display device may have pluralities of source drivers. FIG. 7 is a block diagram illustrating a display device including eight source drivers 261˜268. The source drivers 261˜268 may include output control circuits 271˜278, respectively. The output control circuits 271˜278 may be the same as or substantially similar to those shown in FIG. 4.

Referring to FIG. 7, while the source drivers 261˜268 may each include the output control circuits 271˜278, it may not be always necessary to arrange such individual inclusion with the output control circuit for the source driver. Alternatively, the source drivers 261˜268 may share a single output control circuit.

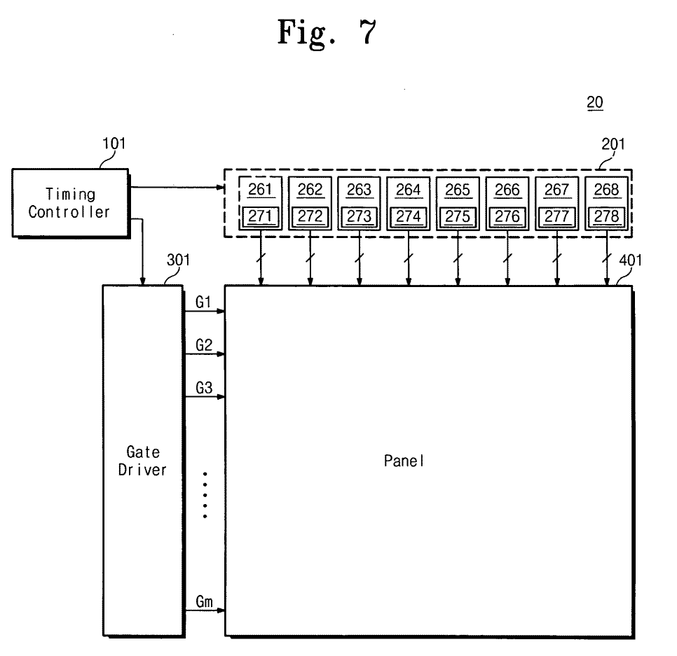

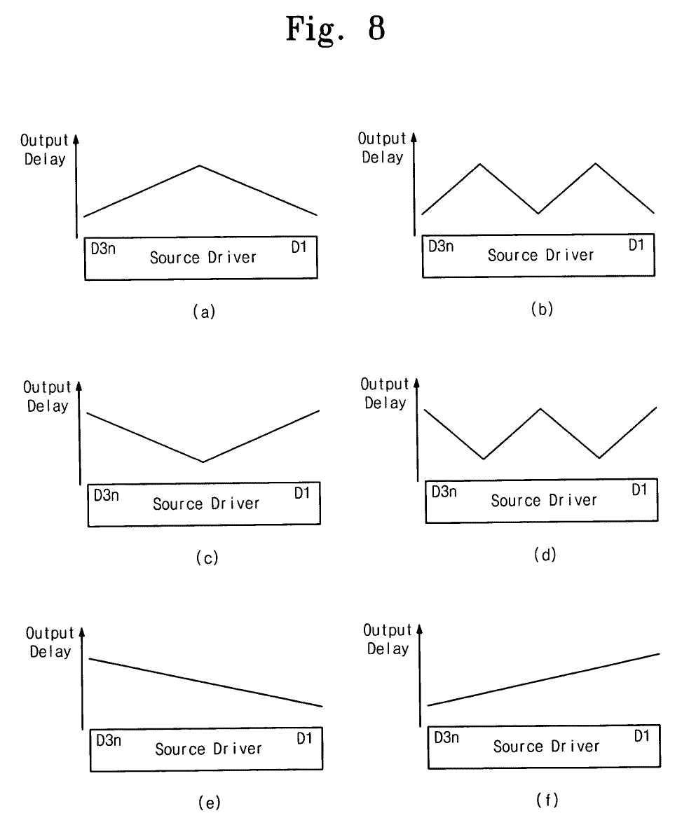

The source drivers 261˜268 may generate pluralities of data-line drive signals that may be delayed in sequence, respectively. In this case, differences between output delay times of the data-line drive signals may be maximized or increased at the boundaries of the source drivers 261˜268, which may result in deterioration in image quality. For the purpose of solving the problem, an output from a data drive circuit of the source driver may be designed as shown in FIGS. 8A through 8D. Referring to FIGS. 8A˜8F, the data-line drive signals may output from both ends of the source driver at the same time. But if there is no influence to image quality even with a difference of delay times between the first and end points, the delay time for output may result in the waveform as like as shown in FIGS. 8E through 8F.

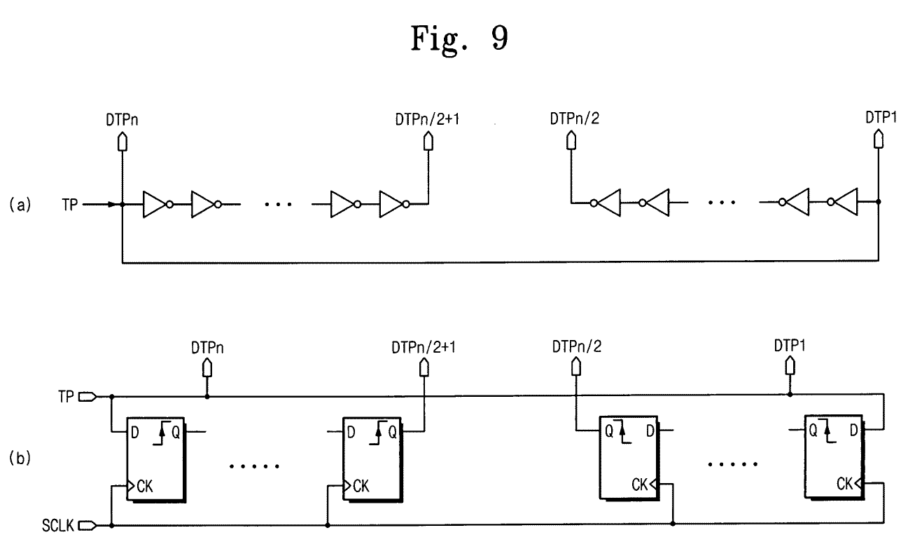

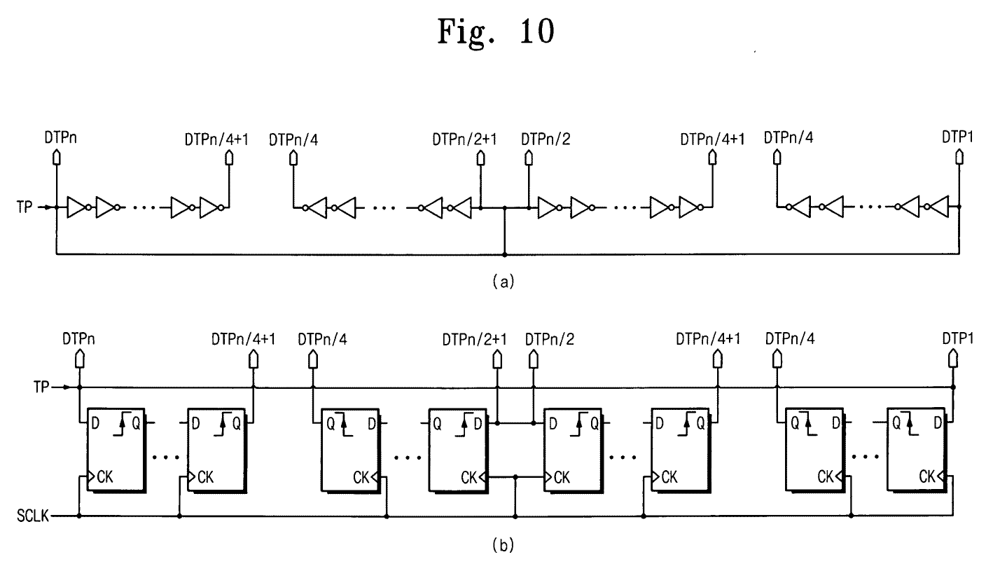

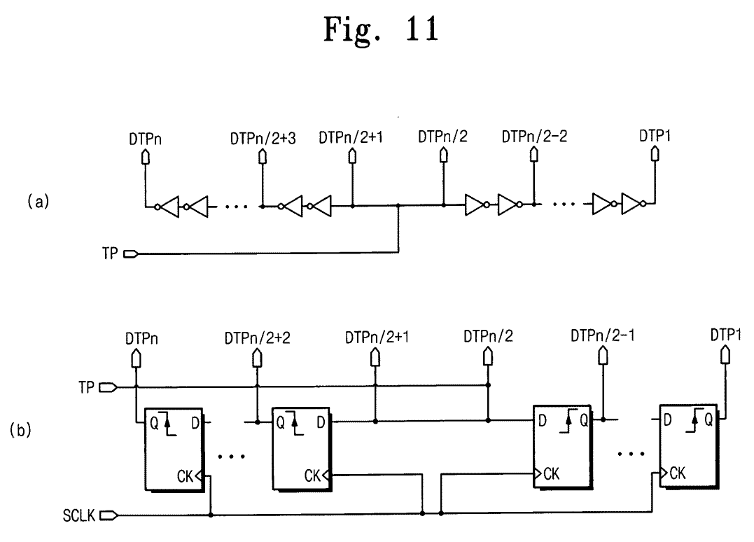

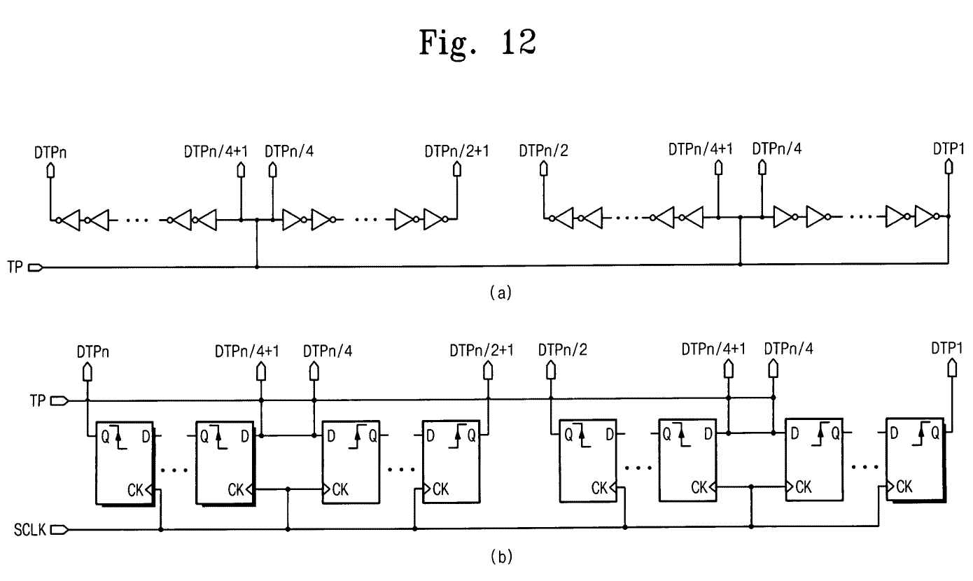

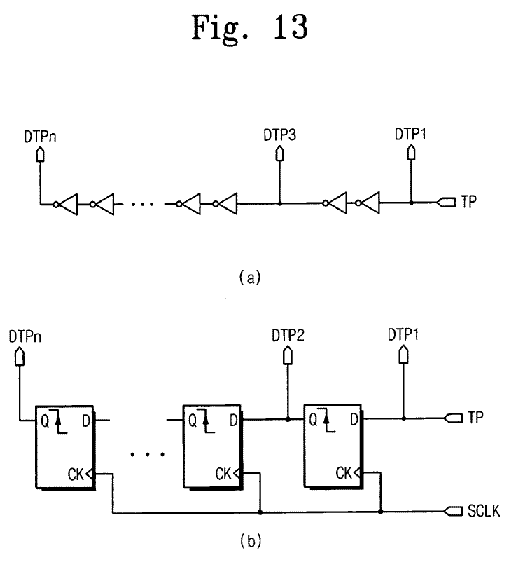

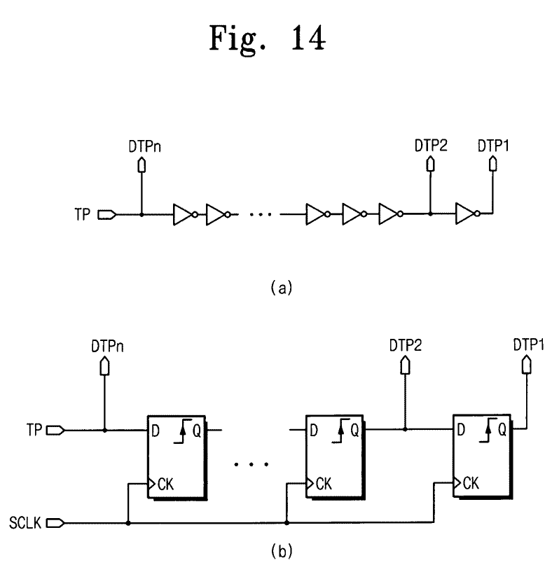

FIGS. 9A and 9B show the output control circuit for the output waveforms shown in FIG. 8A according to example embodiments. FIG. 9A illustrates the output control circuit with inverters while FIG. 9B illustrates the output control circuit with flipflops. FIGS. 10A and 10B show the output control circuit for the output waveforms shown in FIG. 8B according to example embodiments. FIG. 10A illustrates the output control circuit with inverters while FIG. 10B illustrates the output control circuit with flipflops. FIGS. 11A and 11B show the output control circuit for the output waveforms shown in FIG. 8C according to example embodiments. FIG. 11A illustrates the output control circuit with inverters while FIG. 11B illustrates the output control circuit with flipflops. FIGS. 12A and 12B show the output control circuit for the output waveforms shown in FIG. 8D according to example embodiments. FIG. 12A illustrates the output control circuit with inverters while FIG. 12B illustrates the output control circuit with flipflops. FIGS. 13A and 13B show the output control circuit for the output waveforms shown in FIG. 8E according to example embodiments. FIG. 13A illustrates the output control circuit with inverters while FIG. 13B illustrates the output control circuit with flipflops. FIGS. 14A and 14B show the output control circuit for the output waveforms shown in FIG. 8F according to example embodiments. FIG. 14A illustrates the output control circuit with inverters while FIG. 14B illustrates the output control circuit with flipflops.

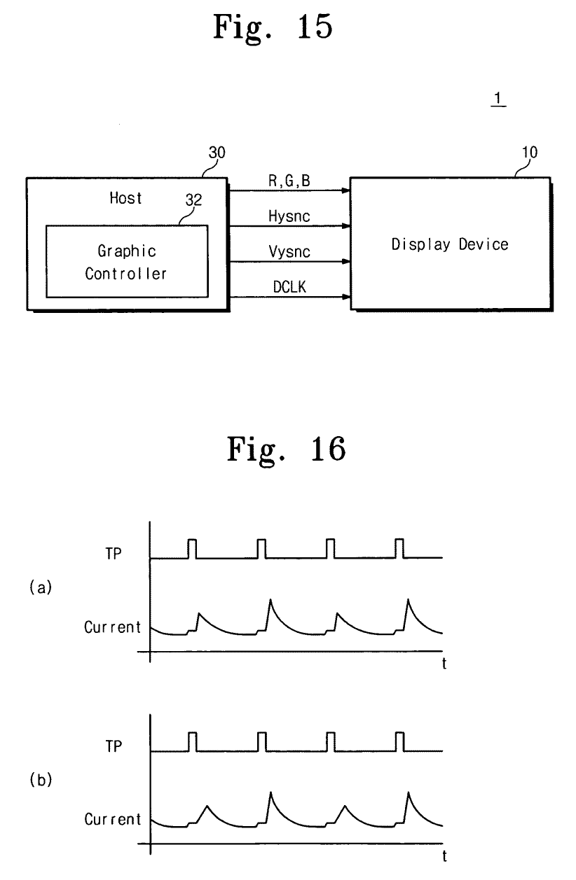

FIG. 15 is a block diagram of a display system 1 including the display device 10 according to example embodiments. Referring to FIG. 15, the display system 1 may be comprised of the display device 10 and a host 30. The display device 10 may operate to express a color image on the panel by receiving color data RGB, a horizontal sync signal Hsync, a vertical sync signal Vsync, and a dor clock signal DCLK from a graphic controller 32 of the host 30. Here, the display device 10 is the same as that of FIG. 3.

FIGS. 16A and 16B show waveforms of current consumed through the source driver. FIG. 16A shows an example of the current waveform of a conventional display device while FIG. 16B shows an example of the current waveform of the display device according to example embodiments. As FIGS. 16A and 16B illustrate, the display device according to example embodiments may be better than the conventional one in reducing a variation rate of peak current.

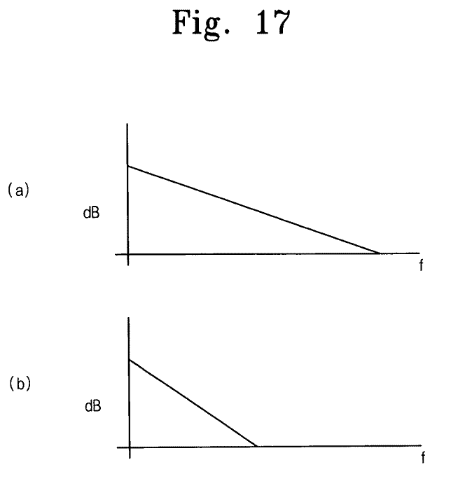

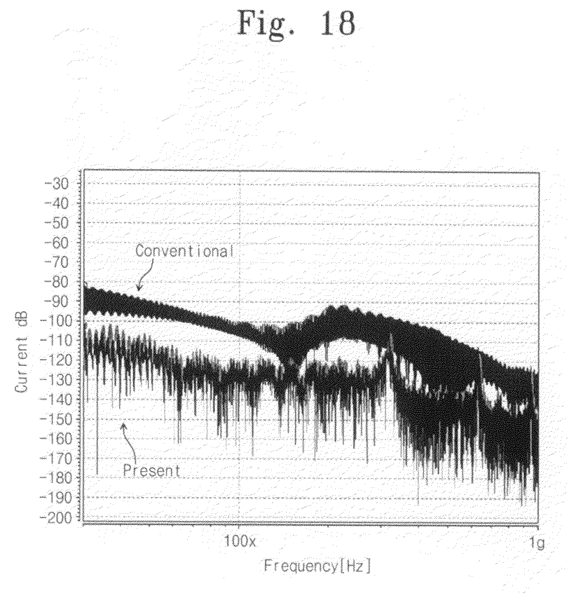

FIGS. 17A and 17B show the current waveforms of FIGS. 16A and 16B in frequency domain. As FIGS. 17A and 17B illustrate, the display device according to example embodiments may be better than the conventional one in frequency characteristic. FIG. 18 shows an example of a simulation result for frequency characteristics of current. Referring to FIG. 18, the display device according to example embodiments may be more effective than the conventional one in reducing the frequency of current by about 20 dB.

The display device according to example embodiments may be helpful in reducing an inclination of peak current transiently consumed by the display device by distributionally outputting outputs of the source driver. This output feature contributes to lessening EMI.

As described above, the display device according to example embodiments is advantageous to lessening EMI by providing the panel with data sequentially, not in a single lump.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. An output method of a source driver, comprising:
receiving image data;
converting the image data into analog image signals; and
distributionally outputting the analog image signals based on pluralities of delayed control signals.

2. The output method as set forth in claim 1, wherein outputting the image signals is comprised of amplifying the image signals.

3. The output method as set forth in claim 2, wherein the image signals are divided into pluralities of groups, the groups of which are independently amplified.

4. The output method as set forth in claim 3, wherein outputting the image signals is further comprised of generating the pluralities of delayed control signals by delaying an external control signal, and delayed control signals from among the pluralities of delayed control signals, are each applied to corresponding groups from among the pluralities of groups.

5. The output method as set forth in claim 4, wherein the delayed control signals are delayed in sequence by a reference amount of time.

6. The output method as set forth in claim 4, wherein adjacent control signals, from among the delayed control signals, are delayed with respect to one another by a reference amount of time,
the delayed control signals output from both ends of a source driver are generated at the same time and
the image signals are delayed in a form of function in response to the control signals.

7. A source driver comprising:
a data latch block receiving and storing image data;
a digital-to-analog converter transforming the image data into analog signals; and
an output amplifier block distributionally outputting the analog signals in response to pluralities of delayed control signals.

8. The source driver as set forth in claim 7, further comprising: an output control circuit generating the pluralities of delayed control signals.

9. The source driver as set forth in claim 8, wherein the output control circuit generates the pluralities of delayed control signals by delaying an external control signal.

10. The source driver as set forth in claim 9, wherein the pluralities of delayed control signals are generated in sequence with delays of a reference amount of time.

11. The source driver as set forth in claim 10, wherein adjacent control signals, from among the pluralities of delayed control signals, are delayed by the reference amount of time, and
wherein delayed control signals, from among the pluralities of delayed control signals, output from both ends of the source driver are generated at the same time.

12. The source driver as set forth in claim 10, wherein the output control circuit comprises pluralities of inverters.

13. The source driver as set forth in claim 10, wherein the output control circuit comprises pluralities of flipflops outputting the pluralities of delayed control signals in sync with a shift clock.

14. A display device comprising the source driver described in claim 7.

15. The display device as set forth in claim 14, wherein the display device is a non-emissive type displaying grays by applying a voltage, that is one of a liquid crystal or a electro-chromic display device.

16. A display system comprising:
a host; and
a display device receiving image data and control signals and displaying an image,
wherein the display device receiving image data and control signals and displaying an image is configured as described in claim 14.
